(19) United States
(12) Patent Application Publication
(10) Pub. No.: US 2024/0094359 A1
(43) Pub. Date: Mar. 21, 2024

(54) ITERATIVE HISTOGRAM BINWIDTH OPTIMIZATION METHOD FOR A LIDAR SYSTEM AND LIDAR SYSTEM IMPLEMENTING SAME

(71) Applicant: HUAWEI TECHNOLOGIES CO., LTD., SHENZHEN (CN)

(72) Inventors: Ali Ahmed Ali MASSOUD, Kanata (CA); Zhiping JIANG, Kanata (CA)

(21) Appl. No.: 17/946,415

(22) Filed: Sep. 16, 2022

(51) Int. Cl. G01S 7/4865; G01S 17/42

(52) U.S. Cl. CPC G01S 7/4865; G01S 17/42

(57) ABSTRACT

A LIDAR system and a method for detecting objects are disclosed. The LIDAR system has a controller configured to acquire a plurality of data points representative of detected signals, and perform an iterative process. During the first iteration the controller is configured to determine a first number of bins based on the plurality of data points, and in response to the first number being above a threshold: (i) organize the plurality of data points into the first number of bins, (ii) identify a target bin amongst the first number of bins, (iii) determine the distance of a first object based on the target bin; and (iv) determine a reduced plurality of data points based on the plurality of data points, which excludes data points associated with the target bin. During a second iteration, the controller determines a distance of a second object based on the reduced plurality of data points.

### TECHNICAL FIELD

The present disclosure relates to the field of Light Detection and Ranging (LIDAR) systems and in particular to systems and methods for performing an iterative histogram bin width optimization algorithm.

### BACKGROUND

Light Detection and Ranging (LIDAR) is a method for determining ranges (variable distance) by targeting an object or a surface with a radiation (light) source. Broadly, a LIDAR system transmits beams of light towards a region of interest, and detects reflected light beams, such as from objects and surfaces in the region of interest, to generate a representation of the region of interest and the objects. Lasers emitting pulses of light within a narrow wavelength are often used as the radiation source.

The position and distance of the object can be computed using inter alia Time of Flight (TOF) calculations of the emitted and detected light beam. By computing such positions as “data points”, a digital multi-dimensional representation of the surroundings can be generated. Each point in the point cloud is associated with coordinates in a coordinate space. Additionally, each point can be associated with some additional information such as the distance to the object from the LIDAR system.

A LIDAR system employs a light detection unit for determining the TOF of photons. For example, some LIDAR systems employ Single Photon Multiplier (SiPM) and/or Single Photon Avalanche Diode (SPAD) detectors. They are solid-state, high-gain radiation detectors that produce an output current pulse upon absorption of a photon. These p-n junction sensors with single-photon sensitivity can detect light wavelengths from near-ultraviolet (UV) to near-infrared (IR).

The TOF in SiPM/SPAD LIDAR systems is estimated from the formed Time Correlated Single Photon Counter (TCSPC), or photon “histogram”. Detection and resolution efficiency of such LIDAR systems depends on inter alia a “bin width” size of the histogram.

### SUMMARY

It is an object of the present technology to ameliorate at least some of the inconveniences present in conventional LIDAR systems that organize detected signals into histograms for TOF determination.

One the one hand, a small bin width size can provide the LIDAR system with a high spatial resolution. However, a small bin width size results in a weaker signal detection signal for far objects. On the other hand, selecting a large bin width size results in possible peaks being distinguishable. However, selecting a large bin width size reduces the resolution of the LIDAR system and the detection signal may be washed out by noise. Therefore, there is a need for algorithms for selecting the bin width of such histogram.

Some conventional methods can be used for adapting the bin width size of different histogram portions. Broadly, such methods subdivide the histogram into sub-regions and each sub-region has a respective bin width size. Such methods rely on the relationship between the received signal power and the distance from the LIDAR system. Developers of the present technology have realized that these histogram adaptive binning-based sub-region methods suffer from hard limits—that is, when the peak is located near a border between two sub-regions. Developers of the present technology have realized that performance of these histogram adaptive binning-based sub-region methods is also dependent on reflectivity for the signal power.

Developers of the present technology have developed methods and systems for (i) selecting an optimal bin width that achieves balance between the precision (resolution) and the probability of detection of the LIDAR system, (ii) determining a bin width size that is agnostic to target reflectivity, (iii) enabling detection of multiple objects, and (iv) automatically determining whether the histogram has an echo or pure noise.

Developers of the present technology have realized that the sunlight noise captured by a SiPM/SPAD detector has a uniform distribution along the time domain. Further, developers of the present technology have realized that an optimal number of bins for a uniform distribution is equal to one.

In a first broad aspect of the present technology, there is provided a LIDAR system comprising a light source for emitting signals, a detection unit, and a controller. The controller is configured to acquire, from the detection unit, a plurality of data points representative of detected signals, perform a first iteration of an iterative process for determining a distance of a first object from the LIDAR system based on the plurality of data points. During the first iteration the controller is configured to determine a first number of bins based on the plurality of data points, the first number maximizing a pre-determined metric of the detected signals. In response to the first number being above a pre-determined threshold number of bins, the controller is configured to: (i) organize the plurality of data points into the first plurality of bins, the first plurality of bins including the first number of bins, a given bin being associated with a respective count value; (ii) identify a target bin amongst the first plurality of bins, the target bin being associated with a largest count value amongst respective bins from the first plurality of bins; (iii) determine the distance of the first object based on the target bin; and (iv) determine a reduced plurality of data points based on the plurality of data points, the reduced plurality of data points excluding data points associated with the target bin. The controller is configured to perform a second iteration of the iterative process for determining a distance of a second object from the LIDAR system based on the reduced plurality of data points.

In some embodiments of the LIDAR system, during the second iteration the controller is further configured to determine a second number of bins based on the reduced plurality of data points, the second number maximizing the pre-determined metric of the detected signals. In response to the second number being above the pre-determined threshold number of bins, the controller is configured to: (i) organize the reduced plurality of data points into a second plurality of bins, the second plurality of bins including the second number of bins; (ii) identify a second target bin amongst the second plurality of bins, the second target bin being associated with a largest count value amongst the second plurality of bins; (iii) determine the distance of the second object based on the second target bin; and (iv) determine an other reduced plurality of data points based on the reduced plurality of data points, the other reduced plurality of data points excluding data points associated with the second target bin.

In some embodiments of the LIDAR system, during the second iteration the controller is further configured to: (i) determine a second number of bins based on the reduced plurality of data points, the second number maximizing the pre-determined metric of the detected signals; (ii) in response to the second number being below the pre-determined threshold number of bins, stop the iterative process.

In some embodiments of the LIDAR system, during the second iteration the controller is further configured to: (i) determine a second number of bins based on the reduced plurality of data points, the second number maximizing the pre-determined metric of the detected signals; (ii) in response to the second number being below the pre-determined threshold number of bins, determine that the reduced plurality of data points represents a noise signal.

In some embodiments of the LIDAR system, the detection unit comprises a Single-Photon Avalanche Diode (SPAD) detector and a Time to Digital (TDC) converter.

In some embodiments of the LIDAR system, the detection unit comprises a Silicon Photomultiplier (SiPM) detector and a Time to Digital (TDC) converter.

In some embodiments of the LIDAR system, the LIDAR system is a flash-type LIDAR system.

In some embodiments of the LIDAR system, the controller is further configured to generate a 3D point cloud at least partially based on the distance of the first object from the LIDAR system.

In some embodiments of the LIDAR system, to determine the first number of bins based on the plurality of data points the controller is configured to perform a Knuth technique, the controller is configured to use the pre-determined metric of the detected signals being indicative of interpretability of the detected signal.

In some embodiments of the LIDAR system, the controller is further configured to determine the pre-determined threshold number of bins based on at least one of (i) a maximum detection range of the LIDAR system and (ii) a detection resolution of the LIDAR system.

In a second broad aspect of the present technology, there is provided a method for determining distance of objects from a LIDAR system. The method executable by a controller. The method comprises acquiring a plurality of data points representative of detected signals. The method comprises performing a first iteration of an iterative process for determining a distance of a first object from the LIDAR system based on the plurality of data points. During the first iteration the method includes determining a first number of bins based on the plurality of data points, the first number maximizing a pre-determined metric of the detected signals. In response to the first number being above a pre-determined threshold number of bins, the method includes: (i) organizing the plurality of data points into the first plurality of bins, the first plurality of bins including the first number of bins, a given bin being associated with a respective count value; (ii) identifying a target bin amongst the first plurality of bins, the target bin being associated with a largest count value amongst respective bins from the first plurality of bins; (iii) determining the distance of the first object based on the target bin; and (iv) determining a reduced plurality of data points based on the plurality of data points, the reduced plurality of data points excluding data points associated with the target bin. The method comprises performing a second iteration of the iterative process for determining a distance of a second object from the LIDAR system based on the reduced plurality of data points.

In some embodiments of the method, during the second iteration the method further comprises determining a second number of bins based on the reduced plurality of data points, the second number maximizing the pre-determined metric of the detected signals. In response to the second number being above the pre-determined threshold number of bins, the method comprises: (i) organizing the reduced plurality of data points into a second plurality of bins, the second plurality of bins including the second number of bins; (ii) identifying a second target bin amongst the second plurality of bins, the second target bin being associated with a largest count value amongst the second plurality of bins; (iii) determining the distance of the second object based on the second target bin; and (iv) determining an other reduced plurality of data points based on the reduced plurality of data points, the other reduced plurality of data points excluding data points associated with the second target bin.

In some embodiments of the method, during the second iteration the method further comprises determining a second number of bins based on the reduced plurality of data points, the second number maximizing the pre-determined metric of the detected signals. In response to the second number being below the pre-determined threshold number of bins, the method comprises stopping the iterative process.

In some embodiments of the method, during the second iteration the method further comprises determining a second number of bins based on the reduced plurality of data points, the second number maximizing the pre-determined metric of the detected signals. In response to the second number being below the pre-determined threshold number of bins, the method comprises determining that the reduced plurality of data points represents a noise signal.

In some embodiments of the method, the acquiring the plurality of data points comprises acquiring raw histogram data from a Time to Digital (TDC) converter of a LIDAR system.

In some embodiments of the method, the method further comprises detecting the detected signals by at least one of a Single-Photon Avalanche Diode (SPAD) detector and a Silicon Photomultiplier (SiPM) detector, and digitizing the detected signals into the plurality of data points by a Time to Digital (TDC) converter.

In some embodiments of the method, the LIDAR system is a flash-type LIDAR system.

In some embodiments of the method, the method further comprises generating a 3D point cloud at least partially based on the distance of the first object from the LIDAR system.

In some embodiments of the method, the determining the first number of bins based on the plurality of data points comprises performing a Knuth technique, the pre-determined metric of the detected signals being indicative of interpretability of the detected signal.

In some embodiments of the method, the method further comprises determining the pre-determined threshold number of bins based on at least one of (i) a maximum detection range of the LIDAR system and (ii) a detection resolution of the LIDAR system.

In a third broad aspect of the present technology, there is provided a system for processing a digital signal, the system comprising a Time to Digital converter (TDC) and a controller. The controller is configured to acquire, from the TDC, a plurality of data points representative of the digital signal, and perform a first iteration of an iterative process for determining a feature of an artifact based on the plurality of data points. During the first iteration the controller is configured to determine a first number of bins based on the plurality of data points, the first number maximizing a pre-determined metric of the digital signal. In response to the first number being above a pre-determined threshold number of bins, the controller is configured to: (i) organize the plurality of data points into the first plurality of bins, the first plurality of bins including the first number of bins, a given bin being associated with a respective count value; (ii) identify a target bin amongst the first plurality of bins, the target bin being associated with a largest count value amongst respective bins from the first plurality of bins; (iii) determine the feature of the artifact based on the target bin; and (iv) determine a reduced plurality of data points based on the plurality of data points, the reduced plurality of data points excluding data points associated with the target bin. The controller is configured to perform a second iteration of the iterative process for determining a feature of an other artifact based on the reduced plurality of data points.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Embodiments of the present disclosure will be described by way of example only with reference to the accompanying drawings, in which:

FIG. 1 is a schematic view of a LIDAR system as contemplated in at least some embodiments of the present technology.

FIG. 2 is a flowchart of a method performed by a processor of the LIDAR system of FIG. 1 in at least some embodiments of the present technology.

FIG. 3A is a histogram formed directly from the TDC raw data according to a first scenario.

FIG. 3B is a result of a first iteration of the binning optimization method of FIG. 2 according to the first scenario.

FIG. 3C is a result of a second iteration of the binning optimization method of FIG. 2 according to the first scenario.

FIG. 3D is a result of a third iteration of the binning optimization method of FIG. 2 according to the first scenario.

### DETAILED DESCRIPTION

### System Architecture

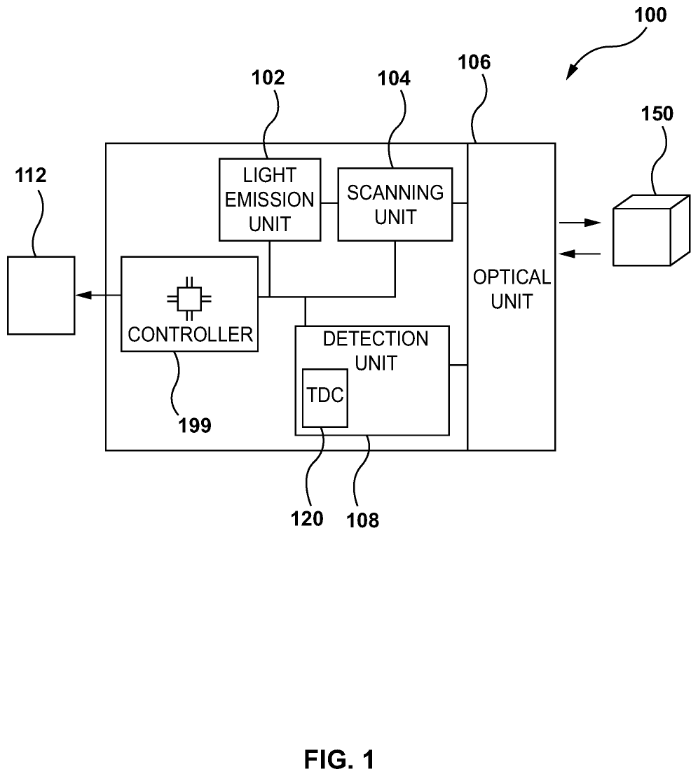

With reference to FIG. 1, there is depicted a schematic view of a LIDAR system 100. In this embodiment, the LIDAR system 100 comprises a light emission unit 102, a scanning unit 104, an optical unit 106, a detection unit 108, and a controller 199.

Broadly speaking, the light emission unit 102 generates a light beam that is provided to the scanning unit 104. The scanning unit 104 is configured to scan the scene by flashing/illuminating the field of view (FOV) of the LIDAR system 100 with the light beam. The light beam is then concentrated through the optical unit designed to fit pixel specifications of the LIDAR system 100. Once the light beam hits an object in the scene, a return beam (pulses) associated with the ambient light noise is reflected towards the optical unit 106. Some of the mixed light beam and ambient light photons are detected by the detection unit 108. Once the detection unit 108 is activated by a photon, the detection unit generates a corresponding electrical current pulse with a certain width. The generated electrical pulse is used for determining a corresponding timestamp. The timestamps are forwarded to a software unit for refining the timestamps and determine the TOF.

How various components of the LIDAR system 100 can be implemented in some embodiments of the present technology will now be discussed in turn.

### Light Source

The light emission unit 102 comprises a driver component and a light source and which is communicatively coupled to the controller 199. The light emission unit 102 is configured to emit light having a given operating wavelength. To that end, in certain non-limiting embodiments of the present technology, the light emission unit 102 could include at least one laser pre-configured for operation at the given operating wavelength. The given operating wavelength of the light emission unit 102 may be in the infrared, visible, and/or ultraviolet portions of the electromagnetic spectrum.

For example, the light emission unit 102 may include at least one laser with an operating wavelength between about 650 nm and 1150 nm. Alternatively, the light emission unit 102 may include a laser diode configured to emit light at a wavelength between about 800 nm and about 1000 nm, between about 850 nm and about 950 nm, or between about 1300 nm and about 1600 nm. In certain other embodiments, the light emission unit 102 could include a light emitting diode (LED).

The light emission unit 102 of the LIDAR system 100 generally includes an eye-safe laser, or put another way, the LIDAR system 100 may be classified as an eye-safe laser system or laser product. Broadly speaking, an eye-safe laser, laser system, or laser product may be a system with some or all of: an emission wavelength, average power, peak power, peak intensity, pulse energy, beam size, beam divergence, exposure time, or scanned output beam such that emitted light from this system presents little or no possibility of causing damage to a person's eyes.

According to certain non-limiting embodiments of the present technology, the operating wavelength of the light emission unit 102 may lie within portions of the electromagnetic spectrum that correspond to light produced by the Sun. Therefore, in some cases, sunlight may act as background noise, which can obscure the light signal detected by the LIDAR system 100. This solar background noise can result in false-positive detections and/or may otherwise corrupt measurements of the LIDAR system 100. Although it may be feasible in some cases to increase a Signal-to-Noise Ratio (SNR) of the LIDAR system 100 by increasing the power level of an output beam, this may not be desirable in at least some situations. For example, it may not in some implementations be desirable to increase power levels of the output beam to levels beyond eye-safe thresholds.

The light emission unit 102 includes a pulsed laser configured to produce, emit, or radiate pulses of light with a certain pulse duration. For example, in some non-limiting embodiments of the present technology, the light emission unit 102 may be configured to emit pulses with a pulse duration (e.g., pulse width) ranging from 10 ps to 10 ns. In other non-limiting embodiments of the present technology, the light emission unit 102 may be configured to emit pulses at a pulse repetition frequency of approximately 2 kHz to 100 MHz or a pulse period (e.g., a time between consecutive pulses) of approximately 10 ns to 500 μs. Overall, however, the light emission unit 102 can generate the output beam with any suitable average optical power, and the output beam may include optical pulses with any suitable pulse energy or peak optical power for a given application.

In some non-limiting embodiments of the present technology, the light emission unit 102 could include one or more laser diodes, including but not limited to: Fabry-Perot laser diode, a quantum well laser, a distributed Bragg reflector (DBR) laser, a distributed feedback (DFB) laser, or a vertical-cavity surface-emitting laser (VCSEL). Just as examples, a given laser diode operating in the light emission unit 102 may be an aluminum-gallium-arsenide (AlGaAs) laser diode, an indium-gallium-arsenide (InGaAs) laser diode, or an indium-gallium-arsenide-phosphide (InGaAsP) laser diode, or any other suitable laser diode. It is also contemplated that the light emission unit 102 may include one or more laser diodes that are current-modulated to produce optical pulses.

In some non-limiting embodiments of the present technology, the light emission unit 102 is generally configured to emit the output beam that is a collimated optical beam, but it is contemplated that the beam produced could have any suitable beam divergence for a given application. Broadly speaking, divergence of the output beam is an angular measure of an increase in beam cross-section size (e.g., a beam radius or beam diameter) as the output beam travels away from the light emission unit 102 or the LIDAR system 100. In some non-limiting embodiments of the present technology, the output beam may have a substantially circular cross-section.

It is also contemplated that the output beam emitted by the light emission unit 102 could be unpolarized or randomly polarized, could have no specific or fixed polarization (e.g., the polarization may vary with time), or could have a particular polarization (e.g., the output beam may be linearly polarized, elliptically polarized, or circularly polarized).

In at least some non-limiting embodiments of the present technology, the output beam and the input beam may be substantially coaxial. In other words, the output beam and input beam may at least partially overlap or share a common propagation axis, so that the input beam and the output beam travel along substantially the same optical path (albeit in opposite directions). Nevertheless, in other non-limiting embodiments of the present technology, the output beam and the input beam may not be coaxial, or in other words, may not overlap or share a common propagation axis inside the LIDAR system 100, without departing from the scope of the present technology.

It should be noted that the LIDAR system 100 forms a plurality of internal beam paths (not numbered) along which the output beam (generated by the light emission unit 102) and the input beam (received from the scene) propagate.

It should be noted that, in various non-limiting embodiments of the present technology, the plurality of internal beam paths may include a variety of optical components. For example, the LIDAR system 100 may include one or more optical components configured to condition, shape, filter, modify, steer, or direct the output beam and/or the input beam. For example, the LIDAR system 100 may include one or more lenses, mirrors, filters (e.g., band pass or interference filters), optical fibers, circulators, beam splitters, polarizers, polarizing beam splitters, wave plates (e.g., half-wave or quarter-wave plates), diffractive elements, microelectromechanical (MEM) elements, collimating elements, or holographic elements.

It is contemplated that in at least some non-limiting embodiments of the present technology, the given internal beam path and the other internal beam path from the plurality of internal beam paths may share at least some common optical components, however, this might not be the case in each and every embodiment of the present technology.

### Scanning Unit

Generally speaking, the scanning unit 104, or a “beam-steering” unit, steers the output beam in one or more directions downrange towards the scene. The scanning unit 104 is communicatively coupled to the controller 199. As such, the controller 199 is configured to control the scanning unit 104 so as to guide the output beam in a desired direction downrange and/or along a predetermined scan pattern. It can be said that the controller 199 is configured to provide an angular control functionality to the scanning unit 104.

The scanning unit 104 can steer the output beam along a “scan pattern”. In certain non-limiting embodiments of the present technology, the controller 199 is configured to cause the scanning unit 104 to scan the output beam over a variety of horizontal angular ranges and/or vertical angular ranges; the total angular extent over which the scanning unit 104 scans the output beam is sometimes referred to as the FOV. It is contemplated that the particular arrangement, orientation, and/or angular ranges could depend on the particular implementation of the LIDAR system 100. The FOV generally includes a plurality of regions of interest, defined as portions of the FOV which may contain, for instance, objects or surfaces of interest. In some implementations, the scanning unit 104 can be configured to further investigate a selected region of interest. The region of interest of the LIDAR system 100 may refer to an area, a volume, a region, an angular range, and/or portion(s) of the scene about which the LIDAR system 100 may be configured to scan and/or can capture data.

According to certain non-limiting embodiments of the present technology, the scanning unit 104 may be configured to scan the output beam horizontally and/or vertically, and as such, the region of interest of the LIDAR system 100 may have a horizontal direction and a vertical direction. For example, the region of interest may be defined by 45 degrees in the horizontal direction, and by 45 degrees in the vertical direction. In some implementations, different scanning axes could have different orientations.

In some embodiments, the scanning unit 104 may include a plurality of reflective components configured to redirect the output beam along a first axis and a second axis. In some cases, the second axis can be perpendicular and/or orthogonal to the first axis. As such, so-redirecting and so-spreading the output beam allows to scan the surroundings 250 of the vehicle 220 along at least two perpendicular/orthogonal axes.

In certain non-limiting embodiments of the present technology, the scanning unit 104 may further include a variety of other optical components and/or mechanical-type components for performing the scanning of the output beam. For example, the given scanning unit may include one or more mirrors, prisms, lenses, MEM components, piezoelectric components, optical fibers, splitters, diffractive elements, collimating elements, and the like. It should be noted that the scanning unit may also include one or more additional actuators (not separately depicted) driving at least some of the other optical components to rotate, tilt, pivot, or move in an angular manner about one or more axes, for example.

### Detection Unit

According to certain non-limiting embodiments of the present technology, the detection unit 108 is communicatively coupled to the controller 199 and may be implemented in a variety of ways. The detection unit 108 includes a photodetector, but could include a photoreceiver, optical receiver, optical sensor, detector, optical detector, optical fibers, and the like. As mentioned above, in some non-limiting embodiments of the present technology, the detection unit 108 may be configured to acquire or detects at least a portion of the input beam and produces an electrical signal that corresponds to the input beam. For example, if the input beam includes an optical pulse, the detection unit 108 may produce an electrical current or voltage pulse that corresponds to the optical pulse detected by the detection unit 108.

It is contemplated that, in various non-limiting embodiments of the present technology, the detection unit 108 may be implemented with one or more avalanche photodiodes (APDs), one or more single-photon avalanche diodes (SPADs), a single-photon multiplier (SiPM) array, one or more PN photodiodes (e.g., a photodiode structure formed by a p-type semiconductor and a n-type semiconductor), one or more PIN photodiodes (e.g., a photodiode structure formed by an undoped intrinsic semiconductor region located between p-type and n-type regions), and the like.

In some non-limiting embodiments, the detection unit 108 may also include circuitry that performs signal amplification, sampling, filtering, signal conditioning, analog-to-digital conversion, time-to-digital conversion, pulse detection, threshold detection, rising-edge detection, falling-edge detection, and the like. For example, the detection unit 108 may include electronic components configured to convert a received photocurrent (e.g., a current produced by an APD in response to a received optical signal) into a voltage signal. The detection unit 108 may also include additional circuitry for producing an analog or digital output signal that corresponds to one or more characteristics (e.g., rising edge, falling edge, amplitude, duration, and the like) of a received optical pulse.

In at least some embodiments of the present technology, the detection unit 108 includes a plurality of SPADs (SiPM array) and a Time to Digital Converter (TDC). In at least some implementations, the TDC may be a TDC7200 model, manufactured by Texas Instruments™ in Dallas, Texas.

### Controller

Depending on the implementation, the controller 199 may include one or more processors, an application-specific integrated circuit (ASIC), a field-programmable gate array (FPGA), and/or other suitable circuitry. The controller 199 may also include non-transitory computer-readable memory to store instructions executable by the controller 199 as well as data which the controller 199 may produce based on the signals acquired from other internal components of the LIDAR system 100 and/or may provide signals to the other internal components of the LIDAR system 100. The memory can include volatile (e.g., RAM) and/or non-volatile (e.g., flash memory, a hard disk) components. The controller 199 may be configured to generate data during operation and store it in the memory. For example, this data generated by the controller 199 may be indicative of the data points in the point cloud of the LIDAR system 100.

In addition to collecting data from the detection unit 108, such as “raw” histogram data from the TDC, for example, the controller 199 could also be configured to provide control signals to, and potentially receive diagnostics data from, the light emission unit 102 and the scanning unit 104.

As previously stated, the controller 199 is communicatively coupled to the light emission unit 102, the scanning unit 104, and the detection unit 108. In some non-limiting embodiments of the present technology, the controller 199 may be configured to receive electrical trigger pulses from the light emission unit 102, where each electrical trigger pulse corresponds to the emission of an optical pulse by the light emission unit 102. The controller 199 may further provide instructions, a control signal, and/or a trigger signal to the light emission unit 102 indicating when the light source is to produce optical pulses indicative, for example, of the output beam. In some embodiments, this functionality may be performed, or at least facilitated, by the light driver of the light emission unit 102, without departing from the scope of the present technology.

Just as an example, the controller 199 may be configured to send an electrical trigger signal that includes electrical pulses, so that the light emission unit 102 emits an optical pulse, representable by the output beam, in response to each electrical pulse of the electrical trigger signal. It is also contemplated that the controller 199 may cause the light emission unit 102 to adjust one or more characteristics of output beam produced by the light emission unit 102 such as, but not limited to: frequency, period, duration, pulse energy, peak power, average power, and wavelength of the optical pulses.

By the non-limiting embodiments of the present technology, the controller 199 is configured to determine a TOF value for an optical pulse in order to determine the distance between the LIDAR system 100 and one or more objects in the FOV, as will be described further below. The TOF is based on timing information associated with (i) a first moment in time when a given optical pulse (for example, of the output beam) was emitted by the light emission unit 102, and (ii) a second moment in time when a portion of the given optical pulse (for example, from the input beam) was detected or received by the detection unit 108. In some non-limiting embodiments of the present technology, the first moment may be indicative of a moment in time when the controller 199 emits a respective electrical pulse associated with the given optical pulse; and the second moment in time may be indicative of a moment in time when the controller 199 receives, from the detection unit 108, an electrical signal generated in response to receiving the portion of the given optical pulse from the input beam.

By the non-limiting embodiments of the present technology, the controller 199 is configured to determine, based on the first moment in time and the second moment in time, a TOF value for the emitted pulse of the output beam. The TOF value T is, in a sense, a “round-trip” time for the emitted pulse to travel from the LIDAR system 100 to an object 150 and back to the LIDAR system 100. The controller 199 is thus broadly configured to determine a distance in accordance with the following equation:

$$D = \frac{c \cdot T}{2} , \qquad ( 1 )$$

wherein D is the distance, T is TOF value, and c is the speed of light (approximately 3.0×108 m/s).

As previously alluded to, the LIDAR system 100 may be used to determine the distance to one or more other potential objects located in the scene. By scanning the output beam across the region of interest of the LIDAR system 100 in accordance with the predetermined scan pattern, the controller 199 is configured to map distances (similar to the distance) to respective data points within the region of interest of the LIDAR system 100. As a result, the controller 199 is generally configured to render these data points captured in succession (e.g., the point cloud) in a form of a multi-dimensional map.

As an example, this multi-dimensional map may be used for detecting, or otherwise identifying, objects or determining a shape or distance of potential objects in the scene. It is contemplated that the LIDAR system 100 may be configured to repeatedly/iteratively capture and/or generate point clouds at any suitable rate for a given application.

Data related to the determined TOF and/or distances to objects could be rendered in different informational formats. Additionally or alternatively, at least some functionalities of the controller 199 may be performed remotely from the LIDAR system 100 such as, for example, generation of the 3D point cloud. For example, the controller 199 may be configured to generate TOF values, refine them, and transmit them to an external processor for generation of the 3D point cloud, without departing from the scope of the present technology.

In at least some embodiments of the present technology, the LIDAR system 100 may be implemented as a flash LIDAR system. Broadly speaking, in a flash LIDAR system, the entire FOV can be illuminated with a wide diverging laser beam in a single pulse. This is in contrast to other scanning LIDAR systems, which uses a collimated laser beam that illuminates a single point at a time, and the beam is raster scanned to illuminate the FOV point-by-point. Such an illumination technique may require a different detection scheme. In both scanning and flash LIDAR systems, TOF is used to collect information about both the 3D location and intensity of the light incident on it in every frame. However, in scanning LIDAR systems, this camera contains only a point sensor, while in a flash LIDAR system, the camera contains either a 1D or a 2D sensor array, each pixel of which collects 3D location and intensity information. In both cases, the depth information is collected using the TOF of a laser pulse, which requires the pulsing of the laser and acquisition by the camera to be synchronized.

In some embodiments, the LIDAR system 100 may be used for generating 3D videos with high resolution and accuracy. The high frame rate of the LIDAR system 100 makes it a useful tool for a variety of applications that benefit from real-time visualization, such as highly precise remote landing operations, a 3D elevation mesh of target landscapes, object detection, automotive LIDAR for capturing high speed car movement, and the like.

### Histogram & Iterative Bin Width Selection

Broadly speaking, a histogram is a representation of the distribution of numerical data. To organize data points into a histogram, a given controller (e.g., the controller 199) can “bin”, or “bucket”, a given range of values—that is, divide the entire range of values into a series of intervals, and then count how many values fall into each interval. The bins are usually specified as consecutive, non-overlapping intervals of a given variable. Histogramming techniques can be used in electronic instrumentation and signal processing applications. One example of such electronic instrumentation includes a TDC (e.g., TDC 120 of the detection unit 108).

Broadly speaking, a TDC is a device for recognizing events and providing a digital representation of the time at which they occurred. For example, a TDC may output the time of arrival for each incoming pulse. In some implementations, a TDC may also measure the time interval between two events, rather than some notion of an absolute time. In other implementations, a TDC can be used to measure a time interval and convert it into digital (binary) output. In further implementations, a TDC can be used to determine the time interval between two signal pulses (known as start and stop pulse). For example, measurement is started and stopped when the rising or falling edge of a signal pulse crosses a set threshold. This pattern is seen in many physical experiments and applications such as, but not limited to: applications involving measurements in atomic and high energy physics, applications involving laser ranging (e.g., TOF determination), applications involving testing of integrated circuits and high-speed data transfer.

As previously alluded to, the controller 199 is configured to acquire “raw” histogram data from the TDC (e.g., a plurality of data points indicative of detected signals) and apply one or more computer-implemented procedures onto this data for determining TOF values for detected objects.

Developers of the present technology have realized that the detection and resolution efficiency of the LIDAR system 100 depends on inter alio a bin width size of the histogram used for determining TOF values. In the context of the present technology, the controller 199 is configured to perform an algorithm for iteratively (i) determining a bin width size for organizing a plurality of data points into histogram bins, (ii) determining a TOF based on a bin with a highest count, (iii) removing the data points associated with that bin from the plurality of data points, and (iv) repeating the process with the so-reduced plurality of data points.

Developers of the present technology have realized that optimizing the bin width of the histogram may solve the “trade-off” between the range and spatial resolution of the LIDAR system 100. Also, the iterative process performed during optimization allows detecting multiple objects in the scene—for example, a first object may be detected during the first iteration based on the plurality of data points organized into a first number of bins, and a second object may be detected during a second iteration based on a reduced plurality of data points organized into a second number of bins. As it will be described in greater details herein further below, the iterative optimization process may stop when a current histogram has a uniform distribution, which allows the controller to differentiate between an “echo” in the histogram (presence of an object) and “noise” in the histogram.

### Knuth Method

In at least some non-limiting embodiments of the present technology, the controller 199 may be configured to perform at least some computer-implemented procedures that are rely and/or implement a Knuth method disclosed in an article entitled “Optimal data-based binning for histograms and histogram-based probability density models”, authored by Kevin H. Knuth, published on Sep. 11, 2019, and the content of which is incorporated herein by reference in its entirety. It is contemplated that the Knuth method can be used in different applications like image processing segmentation, acoustic fragment detection, etc.

Broadly, the Knuth method considers the histogram as a piecewise-constant model representation for the density function of the data.

$$h ( x ) = {\sum }_{k = 1}^{M} {h}_{k} \prod ( {x}_{k - 1} , x , {x}_{k} )$$

$$where :$$

$$\prod ( {x}_{k - 1} , x , {x}_{k} ) = \{ \begin{matrix}0 & x < {x}_{k - 1} \\ 1 & {x}_{k - 1} \leq x < {x}_{k} \\ 0 & x \geq {x}_{k}\end{matrix}$$

wherein h(x) is the probability density function, M is the number of histogram bins, and hₖ is the histogram height in the k^{th} bin.

The goal of the Knuth method is to estimate the optimal number of bins (and hence, a bin width) through maximizing the log posterior probability. The log posterior probability is expressed as:

$$Log P = N log M + log Γ ( \frac{M}{2} ) - M log Γ ( \frac{1}{2} ) - log Γ ( N + \frac{M}{2} ) + {\sum }_{k = 1}^{M} log Γ ( {n}_{k} + \frac{1}{2} )$$

wherein Log P is Log Posterior Probability, Nis the total number of all the data samples, M is the number of histogram bins, and nₖ is the number of data samples in the k^{th} bin.

It should be noted that the optimal number of bins (M^{opt}) corresponds to the largest Log P considered, therefore, the optimal binwidth is

$$B {W}^{opt} = \frac{R}{{M}^{opt}}$$

where R is the data range. This method can be used for identifying the uniform distribution (e.g., background noise) since it provides an optimal number of bins for the uniform distribution, which is equal to one. The log posterior probability in the case of a uniform distribution nₖ can be expressed as:

$${n}_{k} = \frac{N}{M}$$

Therefore, the log posterior probability can be re-written as:

$$Log P = N log M + log Γ ( \frac{M}{2} ) - M log Γ ( \frac{1}{2} ) - log Γ ( N + \frac{M}{2} ) + M log Γ ( \frac{N}{M} + \frac{1}{2} )$$

Developers of the present technology have realized that the maximum log posterior probability is located at M=1 for different N values.

Developers of the present technology have further realized that, although the Knuth method can identify the noise with a uniform distribution, it can be less effective in scenarios where multiple objects are located at different distances away from the LIDAR system. By applying a Knuth method to a scenario where two objects are located at 10 meters and 45 meters, respectively, the object located at 45 meters may be indistinguishable from the noise signal.

Having realized the shortcomings of the Knuth method, developers of the present technology have developed methods and systems that employ an iterative histogram binning technique where the bin width can be adapted from one iteration to another.

### Iterative Method

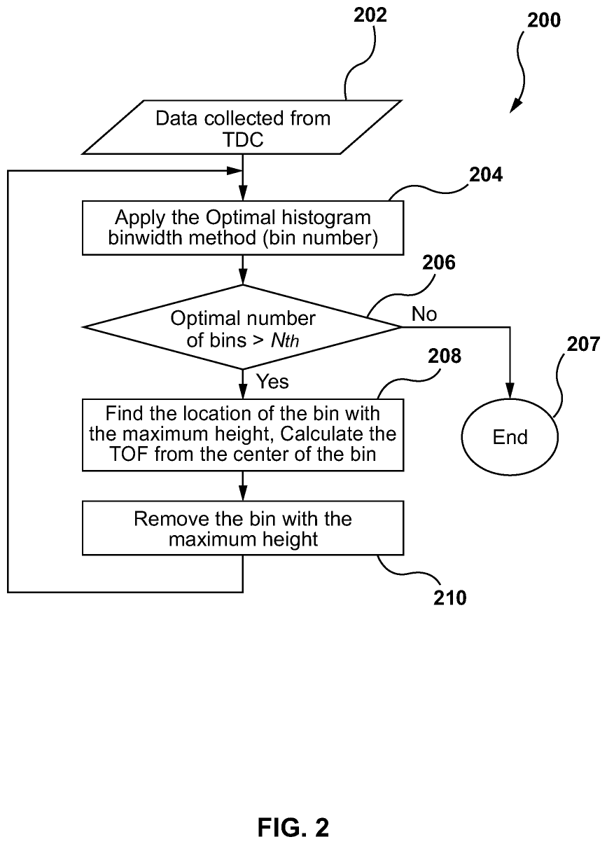

With reference to FIG. 2, there is depicted a flowchart of a method 200 executed by the controller 199 of the LIDAR system 100. The method 200 begins at step 202 with the controller 199 acquiring the data collected from the TDC 120. The collected data comprises a plurality of data points indicative of signals detected by the detector 115. As mentioned above, in some embodiments, the detector 115 may comprise one or more SPADs and/or a SiPM array.

It should be noted that the collected data from the TDC 120 can be organized into a default number of bins by the TDC 120. Therefore, in some embodiments, it can be said that the collected data from the TDC 120 may represent “raw” histogram data provided to the controller 199 by the TDC 120.

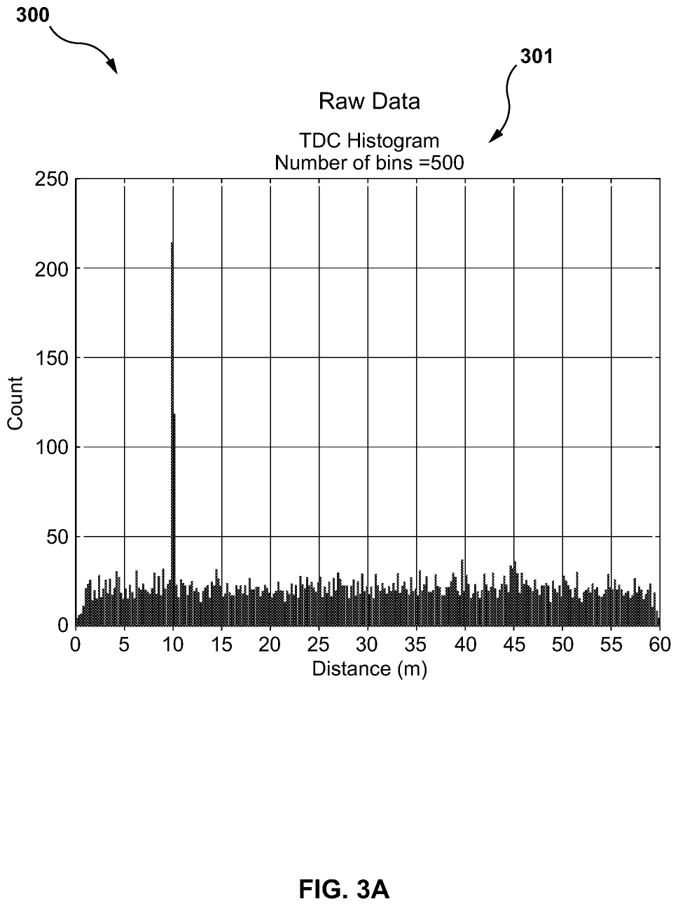

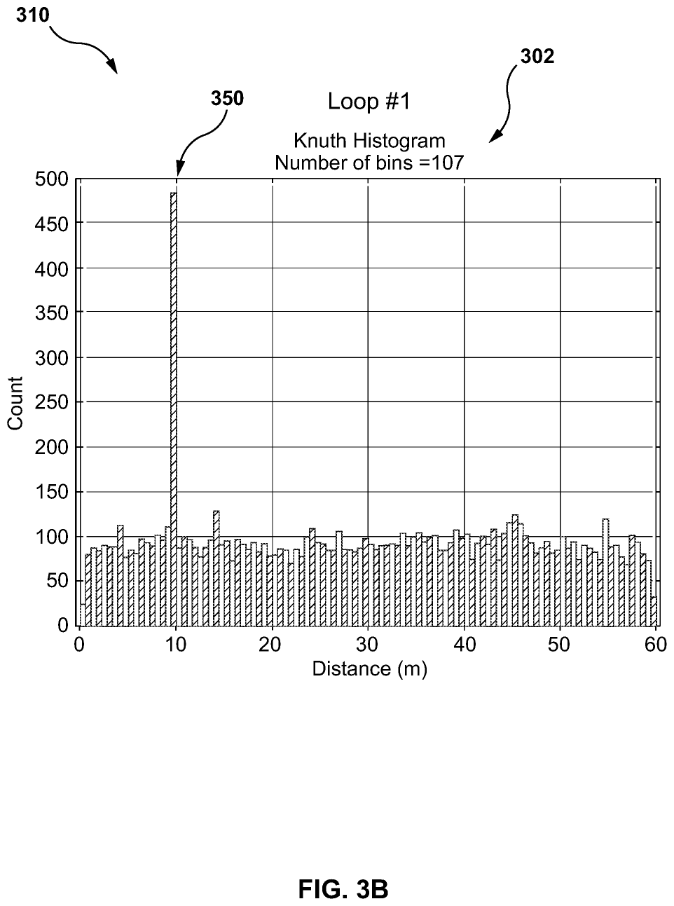

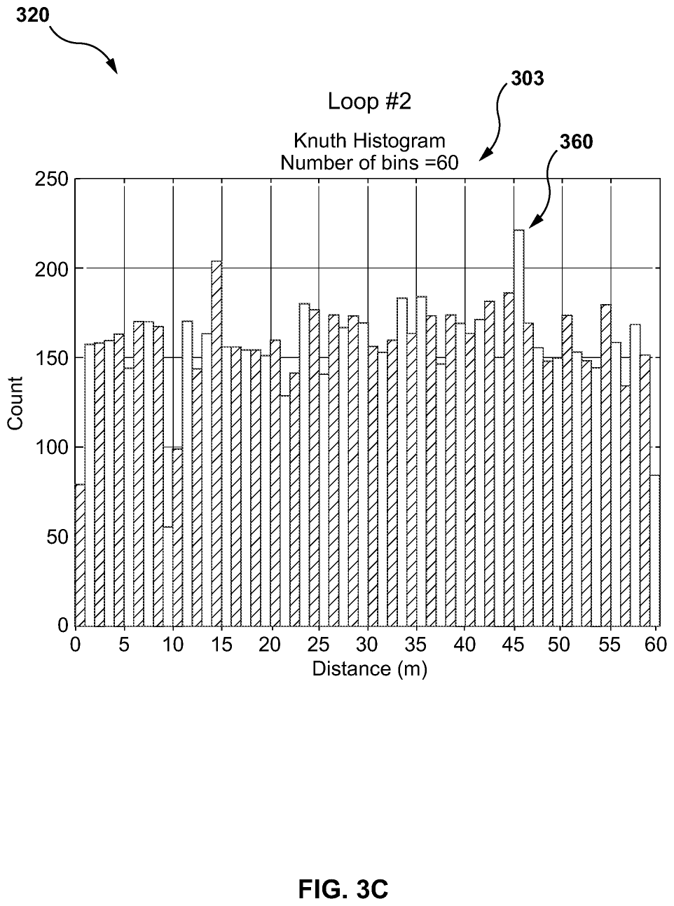

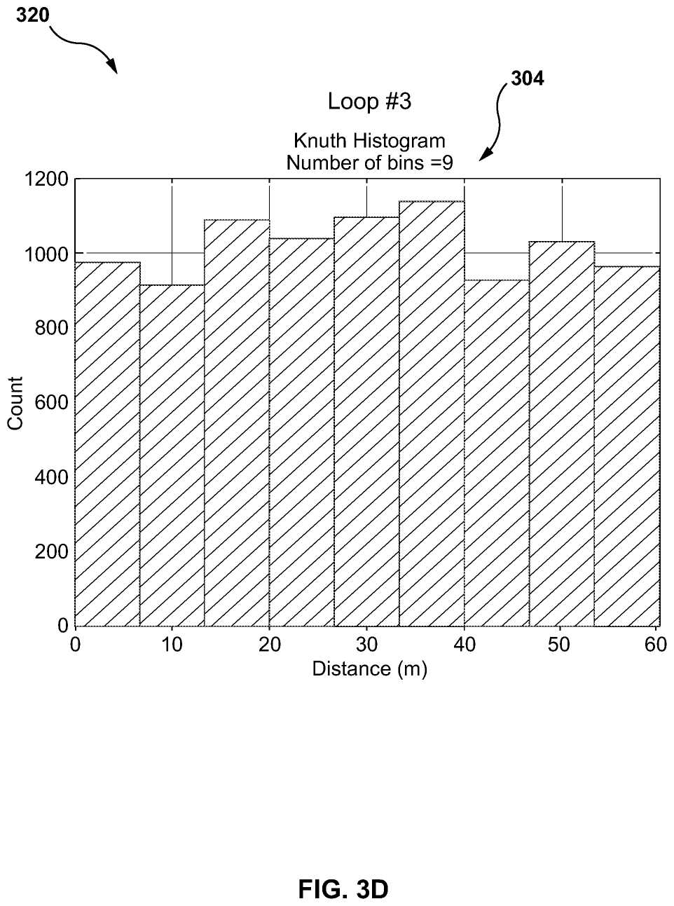

With reference to FIG. 3A, there is depicted a representation 300 of the raw histogram data provided by the TDC 120 to the controller 199. The raw histogram data includes a plurality of data points that has been organized into a default number of bins 201 of the TDC 120. The total number of data points in the plurality of data points depends on inter alia the resolution of the TDC 120. In this implementation, the default number of bins 301 is equal to “500”. In this implementation, a default bin width is equal to a maximum detection range of the LIDAR system 100 (e.g., 60 m) divided by the default number of bins 301.

Returning to the description of FIG. 2, the controller 199 may proceed to step 204 by determining an optimal number of bins for the plurality of data points that maximizes a pre-determined metric. In some embodiments of the present technology, the pre-determined metric may be the Log Posterior Probability Log P of the Knuth method. In these embodiments, the controller 199 may be configured to determine an optimal number of bins for the plurality of data points that maximizes the Log Posterior Probability Log P being indicative of interpretability of the detected signal. It can be said that maximizing the posterior probability results in maximizing the likelihood of the raw signal (histogram) and its representation.

Once the controller 199 determines this optimal number of bins, the controller 199 proceeds to step 206 for verifying whether this optimal number of bins for the first iteration is above a pre-determined threshold number of bins. In this scenario, let it be assumed that the optimal number of bins that maximizes the Log Posterior Probability Log P is equal to “107”. Therefore, in this scenario, the controller 199 is configured to determine whether 107 is above, or below, the pre-determined threshold number of bins.

How the pre-determined threshold number of bins is determined by the controller 199 may depend on inter alia various implementations of the present technology. Theoretically, the pre-determined threshold number of bins Nₜₕ can be equal to 1 when the background noise has a uniform distribution. However, in practical applications, Nₜₕ value can be determined by the controller 199 to be above 1, since the number of the scanning pulses is limited, and the background noise may not be exactly uniform. For example, in the scenario illustrated in FIGS. 3A-3D, Nₜₕ value is equal to “10”. In other implementations however, the Nₜₕ value may be determined based on resolution requirements and maximum detection range requirements of the LIDAR system 100 for a specific application thereof.

As a result of the comparison performed at the step 206, the controller 199 determines that the optimal number of bins for the first iteration (equal to “107”) is above the pre-determined threshold number of bins Nₜₕ (equal to “10”). The method 200 hence proceeds to step 208 with the controller 199 configured to identify a given target bin amongst the plurality of data points organized into the “107” bins.

With reference to FIG. 3B, there is depicted a representation 310 of the plurality of data points organized into the optimal number of bins 302 for the first iteration. The controller 199 may be configured to compare the counts associated with each of the “107” bins (a number of data points that fall into a respective bin) and identify the bin with the highest count as the target bin. In this implementation, the controller 199 identifies a bin 350 as the target bin for the first iteration. The bin 350 corresponds to a peak associated with a distance of 10 m which is indicative of an object being present at 10 m from the LIDAR system 100. In other implementations, a given peak may be associated with a TOF value, instead of a distance value, without departing from the scope of the present technology. The distance value and/or TOF value can be further transmitted by the controller 199 to the software unit 118 for the purpose of generating a point cloud.

The method 200 continues to step 210 with the controller 199 removing the data points falling within the target bin 350 from the plurality of data points, thereby generating a reduced plurality of data points.

The controller 199 is then configured to iteratively repeat the above-described steps on the so-reduced plurality of data points. More particularly, the controller 199 may repeat the step 204, during a second iteration, by determining an optimal number of bins for the so-reduced plurality of data points that maximizes the pre-determined metric.

In this scenario, let it be assumed that the optimal number of bins for the so-reduced plurality of data points that maximizes the pre-determined metric is equal to “60”. Therefore, in this scenario, the controller 199 is configured to determine whether “60” is above, or below, the pre-determined threshold number of bins Nₜₕ.

In this scenario, the controller 199 determines that the optimal number of bins for the second iteration (equal to “60”) is above the pre-determined threshold number of bins Nₜₕ (equal to “10”). The method 200 hence repeats the step 208 with the controller 199 identifying a given target bin amongst the so-reduced plurality of data points organized into the “60” bins.

With reference to FIG. 3C, there is depicted a representation 320 of the so-reduced plurality of data points organized into the optimal number of bins 303 for the second iteration. The controller 199 may be configured to compare the counts associated with each of the “60” bins and identify the bin with the highest count as the target bin for the second iteration. In this implementation, the controller 199 identifies a bin 360 as the target bin for the second iteration. The bin 360 corresponds to a peak associated with a distance of 45 m which is indicative of another object being present at 45 m from the LIDAR system 100. This information can be further transmitted by the controller 199 to the software unit 118 for the purpose of generating the point cloud.

The controller 199 repeats the step 210 and removes the data points falling within the target bin 360 from the so-reduced plurality of data points, thereby generating a newly reduced plurality of data points.

The controller 199 is then configured to iteratively repeat the above-mentioned steps on the newly reduced plurality of data points. More particularly, the controller 199 may repeat the step 204, during a third iteration, by determining an optimal number of bins for the newly reduced plurality of data points that maximizes the pre-determined metric.

In this scenario, let it be assumed that the optimal number of bins for the newly reduced plurality of data points that maximizes the pre-determined metric is equal to “9”. Therefore, in this scenario, the controller 199 is configured to determine whether “9” is above, or below, the pre-determined threshold number of bins Nth.

In this scenario, the controller 199 determines that the optimal number of bins for the third iteration (equal to “9”) is below the pre-determined threshold number of bins Nₜₕ (equal to “10”). The method 200 therefore proceeds to step 207 with the controller 199 stopping the iterative process.

With reference to FIG. 3D, there is depicted a representation 330 of the newly reduced plurality of data points organized into the optimal number of bins 304. It should be noted that when the optimal number of bins for a given iteration is below the pre-determined threshold number of bins Nₜₕ, the controller 199 may or may not be configured to actually organize the data points into the optimal number of bins. Instead, the controller 199 may determine that the newly reduced plurality of data points is representative of a noise signal detected by the LIDAR system 100.

In this implementation, the object distances of 10 m and of 45 m can be transmitted by the controller 199 to the software unit 118 where the point clouds are formed and a 3D representation of the surroundings is processed. It is contemplated that the processing executed by the software unit 118 may be performed by the controller 199, without departing from the scope of the present technology.

In additional embodiments of the present technology, it is contemplated that methods, processors and/or controllers discussed above can be used for other applications than TOF determination. Developers of the present technology have realized that techniques disclosed herein can be used in the context of other applications with uniform noise distribution. In at least some embodiments, the techniques disclosed herein can be used in data mining and classification tasks. It is contemplated that other artifacts (other than TOF information, for example) may be determined from a received signal in other applications of the present technology and using the techniques described herein.

Those of ordinary skill in the art will realize that the descriptions of various embodiments are illustrative only and are not intended to be in any way limiting. Other embodiments will readily suggest themselves to such persons with ordinary skill in the art having the benefit of the present disclosure. Furthermore, at least some of the disclosed embodiments may be customized to offer valuable solutions to existing needs and problems related to histogram binning of digital signals. In the interest of clarity, not all of the routine features of the implementations of the at least some of the disclosed embodiments are shown and described.

In particular, combinations of features are not limited to those presented in the foregoing description as combinations of elements listed in the appended claims form an integral part of the present disclosure. It will, of course, be appreciated that in the development of any such actual implementation of the at least some of the disclosed embodiments, numerous implementation-specific decisions may need to be made in order to achieve the developer's specific goals, such as compliance with application-, system-, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of feedback equalization at high-data rates having the benefit of the present disclosure.

In accordance with the present disclosure, the components, process operations, and/or data structures described in herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of operations is implemented by a computer, a processor operatively connected to a memory, or a machine, those operations may be stored as a series of instructions readable by the machine, processor or computer, and may be stored on a non-transitory, tangible medium.

Systems and modules described herein may comprise software, firmware, hardware, or any combination(s) of software, firmware, or hardware suitable for the purposes described herein. Software and other modules may be executed by a processor and reside on a memory of servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

The present disclosure has been described in the foregoing specification by means of non-restrictive illustrative embodiments provided as examples. These illustrative embodiments may be modified at will. The scope of the claims should not be limited by the embodiments set forth in the examples, but should be given the broadest interpretation consistent with the description as a whole.

1. A LIDAR system comprising a light source for emitting signals, a detection unit, and a controller, the controller being configured to:
acquire, from the detection unit, a plurality of data points representative of detected signals;
perform a first iteration of an iterative process for determining a distance of a first object from the LIDAR system based on the plurality of data points, during the first iteration the controller being configured to:
determine a first number of bins based on the plurality of data points, the first number maximizing a pre-determined metric of the detected signals;
in response to the first number being above a pre-determined threshold number of bins:
organize the plurality of data points into the first plurality of bins, the first plurality of bins including the first number of bins, a given bin being associated with a respective count value;
identify a target bin amongst the first plurality of bins, the target bin being associated with a largest count value amongst respective bins from the first plurality of bins;
determine the distance of the first object based on the target bin; and
determine a reduced plurality of data points based on the plurality of data points, the reduced plurality of data points excluding data points associated with the target bin;
perform a second iteration of the iterative process for determining a distance of a second object from the LIDAR system based on the reduced plurality of data points.

2. The LIDAR system of claim 1, wherein during the second iteration the controller is further configured to:
determine a second number of bins based on the reduced plurality of data points, the second number maximizing the pre-determined metric of the detected signals;
in response to the second number being above the pre-determined threshold number of bins:
organize the reduced plurality of data points into a second plurality of bins, the second plurality of bins including the second number of bins;
identify a second target bin amongst the second plurality of bins, the second target bin being associated with a largest count value amongst the second plurality of bins;
determine the distance of the second object based on the second target bin; and
determine an other reduced plurality of data points based on the reduced plurality of data points, the other reduced plurality of data points excluding data points associated with the second target bin.

3. The LIDAR system of claim 1, wherein during the second iteration the controller is further configured to:
determine a second number of bins based on the reduced plurality of data points, the second number maximizing the pre-determined metric of the detected signals;
in response to the second number being below the pre-determined threshold number of bins:
stop the iterative process.

4. The LIDAR system of claim 1, wherein during the second iteration the controller is further configured to:
determine a second number of bins based on the reduced plurality of data points, the second number maximizing the pre-determined metric of the detected signals;
in response to the second number being below the pre-determined threshold number of bins:
determine that the reduced plurality of data points represents a noise signal.

5. The LIDAR system of claim 1, wherein the detection unit comprises a Single-Photon Avalanche Diode (SPAD) detector and a Time to Digital (TDC) converter.

6. The LIDAR system of claim 1, wherein the detection unit comprises a Silicon Photomultiplier (SiPM) detector and a Time to Digital (TDC) converter.

7. The LIDAR system of claim 1, wherein the LIDAR system is a flash-type LIDAR system.

8. The LIDAR system of claim 1, wherein the controller is further configured to generate a 3D point cloud at least partially based on the distance of the first object from the LIDAR system.

9. The LIDAR system of claim 1, wherein to determine the first number of bins based on the plurality of data points the controller is configured to perform a Knuth technique, the controller is configured to use the pre-determined metric of the detected signals being indicative of interpretability of the detected signal.

10. The LIDAR system of claim 1, wherein the controller is further configured to determine the pre-determined threshold number of bins based on at least one of (i) a maximum detection range of the LIDAR system and (ii) a detection resolution of the LIDAR system.

11. A method for determining distance of objects from a LIDAR system, the method executable by a controller, the method comprising:
acquiring a plurality of data points representative of detected signals;
performing a first iteration of an iterative process for determining a distance of a first object from the LIDAR system based on the plurality of data points, during the first iteration the method including:
determining a first number of bins based on the plurality of data points, the first number maximizing a pre-determined metric of the detected signals;
in response to the first number being above a pre-determined threshold number of bins:
organizing the plurality of data points into the first plurality of bins, the first plurality of bins including the first number of bins, a given bin being associated with a respective count value;
identifying a target bin amongst the first plurality of bins, the target bin being associated with a largest count value amongst respective bins from the first plurality of bins;
determining the distance of the first object based on the target bin; and
determining a reduced plurality of data points based on the plurality of data points, the reduced plurality of data points excluding data points associated with the target bin;
performing a second iteration of the iterative process for determining a distance of a second object from the LIDAR system based on the reduced plurality of data points.

12. The method of claim 11, wherein during the second iteration the method further comprises:
determining a second number of bins based on the reduced plurality of data points, the second number maximizing the pre-determined metric of the detected signals;
in response to the second number being above the pre-determined threshold number of bins:
organizing the reduced plurality of data points into a second plurality of bins, the second plurality of bins including the second number of bins;
identifying a second target bin amongst the second plurality of bins, the second target bin being associated with a largest count value amongst the second plurality of bins;
determining the distance of the second object based on the second target bin; and
determining an other reduced plurality of data points based on the reduced plurality of data points, the other reduced plurality of data points excluding data points associated with the second target bin.

13. The method of claim 11, wherein during the second iteration the method further comprises:
determining a second number of bins based on the reduced plurality of data points, the second number maximizing the pre-determined metric of the detected signals;
in response to the second number being below the pre-determined threshold number of bins:
stopping the iterative process.

14. The method of claim 11, wherein during the second iteration the method further comprises:
determining a second number of bins based on the reduced plurality of data points, the second number maximizing the pre-determined metric of the detected signals;
in response to the second number being below the pre-determined threshold number of bins:
determining that the reduced plurality of data points represents a noise signal.

15. The method of claim 11, wherein the acquiring the plurality of data points comprises acquiring raw histogram data from a Time to Digital (TDC) converter of a LIDAR system.

16. The method of claim 11, wherein the method further comprises detecting the detected signals by at least one of a Single-Photon Avalanche Diode (SPAD) detector and a Silicon Photomultiplier (SiPM) detector, and digitizing the detected signals into the plurality of data points by a Time to Digital (TDC) converter.

17. The method of claim 11, wherein the LIDAR system is a flash-type LIDAR system.

18. The method of claim 11, wherein the method further comprises generating a 3D point cloud at least partially based on the distance of the first object from the LIDAR system.

19. The method of claim 11, wherein the determining the first number of bins based on the plurality of data points comprises performing a Knuth technique, the pre-determined metric of the detected signals being indicative of interpretability of the detected signal.

20. The method of claim 11, wherein the method further comprises determining the pre-determined threshold number of bins based on at least one of (i) a maximum detection range of the LIDAR system and (ii) a detection resolution of the LIDAR system.

21. A system for processing a digital signal, the system comprising a Time to Digital converter (TDC) and a controller, being configured to:
acquire, from the TDC, a plurality of data points representative of the digital signal;
perform a first iteration of an iterative process for determining a feature of an artifact based on the plurality of data points, during the first iteration the controller being configured to:
determine a first number of bins based on the plurality of data points, the first number maximizing a pre-determined metric of the digital signal;
in response to the first number being above a pre-determined threshold number of bins:
organize the plurality of data points into the first plurality of bins, the first plurality of bins including the first number of bins, a given bin being associated with a respective count value;
identify a target bin amongst the first plurality of bins, the target bin being associated with a largest count value amongst respective bins from the first plurality of bins;
determine the feature of the artifact based on the target bin; and
determine a reduced plurality of data points based on the plurality of data points, the reduced plurality of data points excluding data points associated with the target bin;
perform a second iteration of the iterative process for determining a feature of an other artifact based on the reduced plurality of data points.
